(19) United States
(12) Patent Application Publication
(10) Pub. No.: US 2017/0122264 A1
(43) Pub. Date: May 4, 2017

(54) Ethane Conversion System for Internal Combustion Engines

(71) Applicant: Pioneer Energy Inc, Lakewood, CO (US)

(72) Inventors: John Brackett, Lakewood, CO (US); Dan Thorn, Pine, CO (US); Mike Lowe, Denver, CO (US); Robert Zubrin, Golden, CO (US)

(21) Appl. No.: 14/928,967

(22) Filed: Oct. 30, 2015

(51) Int. Cl. F02M 21/02; F02M 21/06

(52) U.S. Cl. CPC F02M 21/0203; F02M 21/06; F02M 21/0221

(57) ABSTRACT

Novel methods and devices to operate internal combustion engines on ethane fuel and blends of ethane fuel are provided where the pressure is controlled to maintain a liquid or vapor phase of the fuel and the fuel is admitted into the engine in a controlled and consistent manner for highly efficient engine performance.

### RELATED APPLICATIONS

This application claims the benefit of U.S. Provisional Application No. 62/073,780 filed Oct. 31, 2014 entitled “Ethane Conversion System for Internal Combustion Engines” which is incorporated herein by reference in its entirety.

### BACKGROUND OF THE INVENTION

The hydrocarbon ethane has saturated the market and is being burned off to the atmosphere in vast quantities. With 22,400 BTUs/lb compared to gasoline's 20,400 BTUs/lb, there is a lot of potential for using this cheap source of fuel in the automotive market. The spot price of gasoline has been over $2.75 per gallon for years now, while ethane has dropped to $0.27 per gallon. There are over 270,000,000 vehicles on roads in the United States, and an additional 25,000,000 being sold each year in China alone. With this ever increasing demand for transportation fueling solutions, cheaper sources of energy are required. Our invention greatly expands the available fuel sources that could be used to power internal combustion engines with cheaper fuel while creating fewer exhaust emissions to the environment. In order to cope with regulations that are demanding increased fuel mileage and reduced emissions, we present a solution that can meet both these needs as well.

### BRIEF DESCRIPTION OF DRAWINGS

FIG. 1 is a diagram for an ethane conversion device, using vapor feed

FIG. 2 is a diagram for an ethane conversion device, using liquid feed

### DETAILED DESCRIPTION OF THE INVENTION

The present invention shows how a novel device can be fit to vehicles on the road today in a manner that will allow for fueling on various high ethane blend fuels. Ethane's performance during our testing indicated improved thermal efficiency and fueling costs that haven't been seen for decades.

Pioneer Energy has run several internal combustion engines on various blends of ethane and other hydrocarbons with very positive results. To accomplish this, the invention takes ethane mixtures from a pressurized storage device with monitoring sensors, the mixture is passed through a pressure altering device and then fed through a metering device prior to combustion. A computer makes use of sensors to alter the amount of metered fuel in order to maintain operation of the internal combustion engine.

Storage containers are filled to a maximum of 80-90% of capacity to allow for expansion in all operating conditions. Sensors on the storage container monitor temperature and pressure of the fuel mixture. When the system is active, fuel flows from this container into a pressure altering device. To ensure controlled pressure change, sensors to monitor temperature and pressure are also installed near or on the pressure altering device. One embodiment and design makes use of sensors directly mounted to the pressure altering device. In another embodiment, the sensors could be installed on the fuel line. Temperature and pressure are monitored to avoid dual liquid/vapor phase flow into the engine. Since the critical temperature of ethane is 89.9 Fahrenheit, it is vaporized or maintained in a liquid state by altering either the temperature or pressure. The heat energy can come from electricity or waste engine heat.

After exiting the pressure altering device, the fuel passes through a filter, before entering the metering device. The experimental setup can use an electrically actuated solenoid as the metering device. The computer provides an electrical signal to determine what quantity of fuel is required to flow through the nozzle. The design of the tip or nozzle can be varied to adjust for engines of different displacements or volumetric efficiencies. The metering device can be of fixed or variable output. After leaving the metering device, the fuel is dispersed into the engine's intake tract. The intake tract moves the air and fuel mixture to the combustion chamber, where power is produced. In another embodiment, the fuel could be injected into the combustion chamber.

The internal combustion engine can be a spark ignition, a compression ignition, a hybrid of spark ignition and compression, i.e. homogenous charge compression ignition, or a turbine.

The computer accepts inputs from the storage container, pressure altering device, and engine sensors. Engine inputs can include but are not limited to crankshaft position, camshaft position, fuel injector pulse, intake manifold pressure, and oxygen sensor. In another embodiment, the computer is replaced with a self-adjusting pressure altering device. In another embodiment, the computer is replaced with a self-regulating metering component. In another embodiment, the computer running the original engine is used.

In one embodiment, a control switch, mounted within the engine operator's reach, can be programmed through the software to run on the original fuel or the high ethane blend. When activated, the control unit will disable the factory fueling system and activate the solenoid for ethane blend operation. In another embodiment, both fueling systems can be active at the same time.

The software and hardware are capable of altering operating conditions for a wide range of fuels to include but not limited to, methane, ethane, propane, butane and various mixtures. In another embodiment, the fuels are mixed with gasoline or diesel as a high pressure liquid. The pressure altering device and metering device are altered to attain proper running conditions dependent upon the fuel mixture.

The components of the present invention may be used on any configuration of internal combustion engine through alteration of the computer software and the metering device. In another embodiment, the internal combustion engine's computer software does not have the software code altered from its original design. Alterations are instead made to the metering device.

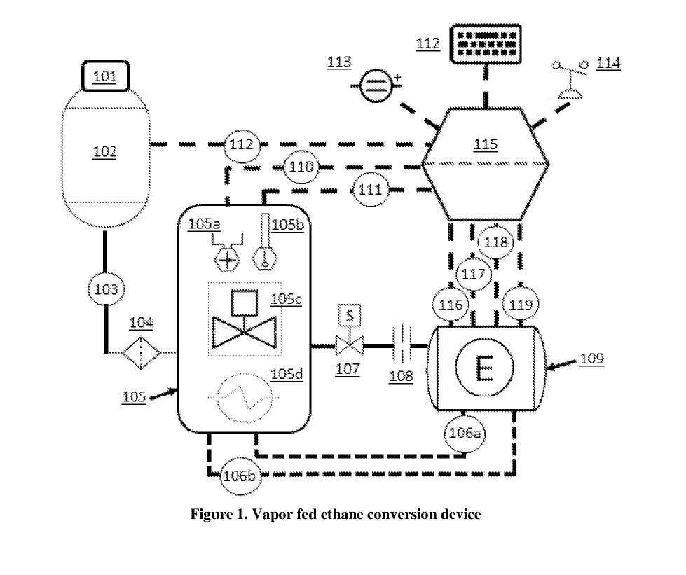

In one variation of the invention, the vehicle can be fueled by the setup outlined in FIG. 1.

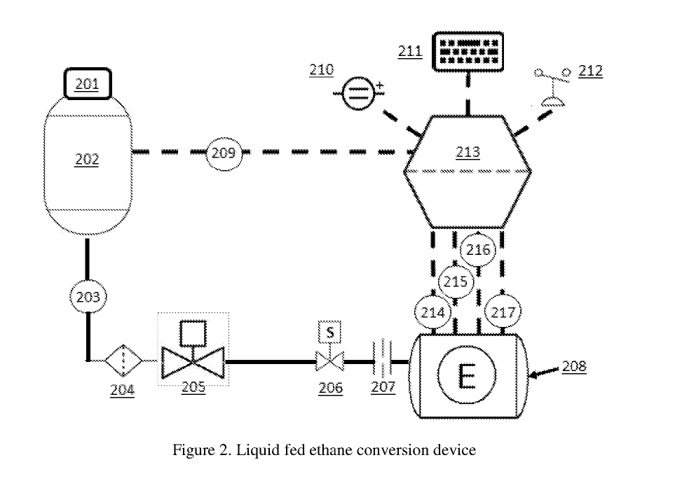

In one variation of the invention, the vehicle can be fueled by the setup outlined in FIG. 2.

One embodiment of the invention uses high ethane blends in a vaporizer setup by use of a single fuel injection source for a single or multiple cylinder engine, rather than one injection solenoid per cylinder

One embodiment of the invention uses a combination solenoid and nozzle to power a multiple cylinder engine with 1 injector per cylinder on high ethane blends.

### DEFINITIONS

Unless specifically noted otherwise herein, the definitions of the terms used are standard definitions used in the art. Exemplary embodiments, aspects and variations are illustrated in the figures and drawings, and it is intended that the embodiments, aspects and variations, and the figures and drawings disclosed herein are to be considered illustrative and not limiting.

The methods of the present invention can comprise, consist of, or consist essentially of the essential elements and limitations of the method described herein, as well as any additional or optional ingredients, components, or limitations described herein or otherwise useful.

Intake tract shall encompass any area after the throttling device and prior to the intake valve.

High ethane blend shall be considered any mixture where the major constituent is ethane. This system also adjusts for blends where ethane is not the predominant fuel.

Nozzle shall entail any venturi or pressure altering setup that changes the state, velocity or distribution of the fuel.

### DETAILED DESCRIPTION OF DRAWINGS

FIG. 1 describes a device that allows an internal combustion engine to run off ethane and a variety of other hydrocarbons. The fuel enters through a fill nozzle (101) installed on a storage tank (102), whose level is measured with a sensor (112) and monitored by the control unit (115). When the system is activated by the control switch (114), fuel is sent down a line (103), through a filter (104), and into the pressure regulating vaporizer (105). In order to inject the hydrocarbon as a vapor, energy must be added through a separate cooling loop (106a & 106b). Concept A utilizes wasted heat energy from the internal combustion engine (109) and sends the coolant through a heat exchanger (105d), which maintains the pressure regulator's (105c) operating conditions. To verify operating parameters are being met, sensors send both the pressure (105a) and temperature (105b) to the control unit (115) through electrical wires (110 & 111). Once the fuel has been vaporized, it is sent to an electrically actuated solenoid (107) that receives power (120) from the control unit (115). Once the solenoid (107) is activated, a nozzle (108) meters the fuel into the internal combustion engine's (109) air inlet. To determine how much fuel is required, an electrical power source (113) allows the control unit (115) to monitor components of the internal combustion engine (109) to include the fuel injector signal (116), manifold absolute pressure sensor [MAP] (117), engine speed [RPM] (118) and the exhaust gas composition via an oxygen sensor (119). In order to optimize for the fuel, parameters are alterable through a computer platform (112) connected to the control unit (115).

FIG. 2 describes another version of the ethane conversion device that makes use of a liquid fuel feed to the internal combustion engine (208). The fuel enters through a fill nozzle (201) installed on a storage tank (202), whose level is measured with a sensor (209) and monitored by the control unit (213). When the system is activated by the control switch (212), fuel is sent down a line (203), through a filter (204), and into the pressure regulator (205). The fuel is then sent to an electrically actuated solenoid (206) that receives power (218) from the control unit (213). Once the solenoid (206) is activated, an orifice (207) meters the fuel into the internal combustion engine's (208) air inlet. To determine how much fuel is required, an electrical power source (210) allows the control unit (213) to monitor components of the internal combustion engine (208) to include the fuel injector signal (214), manifold absolute pressure sensor [MAP] (215), engine speed [RPM] (216) and the exhaust gas composition via an oxygen sensor (217). In order to optimize for the fuel, parameters are alterable through a computer platform (211) connected to the control unit (213).

### Experimental Design

The conversion system was created in accordance with the above principles. The test vehicle running off our system was a 2007 Chevrolet Cobalt with the 2.2 L spark ignited, internal combustion engine. The computer platform made use of EFI Live software to alter the vehicle's computer programming along with the original spark ignition timing to optimize for the gaseous fuel blends tested. Driving conditions were simulated on a Dynocom 5000 dynamometer to provide repeatable results.

The ethane blends were stored within a bottle mounted in the trunk. When filled, the liquid maintains pressures of 800-2200 psi depending on ambient conditions, as read through the pressure gauge. The 1.125-12 British Standard Pipe bottle fitting was adapted to a −4AN flare fitting. The fuel was supplied to an adjustable pressure regulator through a ¼″ braided stainless steel hose. The regulator contains a temperature and pressure sensor, along with a manometer/switch. If the switch does not sense line pressure, the regulator will not allow flow to the solenoids, which reactivates the original fueling system. In order to maintain output fuel pressures of 10-40 psi, the engine waste heat is supplied to the regulator through tapping into the coolant system with 10 mm rubber hose. All rubber hoses are secured with worm gear clamp fittings. The fuel exits as a vapor prior to flowing through a fuel filter connected to the system with 12 mm rubber hose. This filter splits the gas into two dual injector solenoid fuel rails with 1-3 mm nozzles installed on their outlets. The nozzle is connected to a 5 mm rubber hose and an adapter bung specifically for General Motors gasoline injectors. This bung is placed inline and below the injectors, requiring a machined spacer to secure the fuel rail to the engine in its new position.

The Versus Compressed Natural Gas (CNG)/Liquid Propane Gas (LPG) Injection Controller requires input from a pressure sensor, ignition coil, manometer/switch, 12 volt supply, reducer temperature, gas temperature, and fuel injector to accurately power the engine. Pressure is read off the intake manifold through to 5 mm rubber hose and into a MAP sensor.

The controller settings are updateable via a USB cable connected to a computer loaded with the Versus software. Settings must be altered for each different fuel or vehicle the device is installed within Values can be adjusted for changes in sensor types or operating conditions to determine when the system is active.

Our experiments in vehicle have yielded improvements in miles per weight along with an increase in power output. One test vehicle drove 44 miles on 6 pounds of a high ethane blend, where it would normally drive 36 miles on 6 pounds of gasoline. This reports a sharp increase in fuel economy since ethane currently sells for $0.10/lb while gasoline sells for about $0.50/lb.

The power has also noticeably increased using ethane blends with gasoline ignition settings or advancement in timing. The high octane rating of ethane blends, >100 on average, will yield vastly superior gains in high compression or direct injection engines when compared to the 85-93 octane gasoline available, further improving upon our results.

What is claimed is:

1. A device to run internal combustion engines on ethane comprising:
a) A storage device to store fuel and a supply line to the ethane conversion system for said internal combustion engine;
b) A pressure altering device connected to control pressure of feed from said storage device through the supply line;
c) A metering device connected directly to the pressure altering device or through an additional supply line in order to control flow of fuel; and,
d) A computer with sensors connected to said internal combustion engine, pressure altering device, and metering device to receive and process data from the storage, pressure altering and metering devices.

2. The device of claim 1 where the ethane is blended with other fuels.

3. The device of claim 1 where the storage device to store fuel is made of metal or composites.

4. The device of claim 1 where the pressure altering device is a single stage pressure regulator selected from an orifice, a venturi, a nozzle, a throttling device, or a valve.

5. The device of claim 1 where the pressure altering device is a multiple stage pressure regulator selected from an orifice, a venturi, a nozzle, a throttling device, or a valve.

6. The device of claim 1 where the metering device is selected from a solenoid, a nozzle, an orifice, or an injector.

7. The device of claim 1 where the metering device can be configured to be fixed, variable, On/Off configuration, electronically controlled or self-adjusting.

8. The device of claim 1 where the metering device is a combination of a solenoid, a nozzle, an orifice, or an injector.

9. The device of claim 1 where the pressure altering device and metering device are integrated as one device.

10. The device of claim 1 where the computer is selected from a self-adjusting pressure altering device, a self-regulating metering component, or the one running the original engine.

11. The device of claim 1 where the intake tract extends from the engine intake filter to the combustion chamber

12. A device of claim 1 where device is installed on a spark ignition, internal combustion engine, a compression ignition, internal combustion engine, a hybrid of spark ignition and compression, i.e. homogenous charge compression ignition, or where the internal combustion engine is a turbine.

13. A device of claim 1 where the computer controls operating parameters based on data received and adjusts to maintain internal combustion engine operation.

14. A process to run an internal combustion engine on ethane fuel comprising the steps of:
a) Drawing a ethane fuel from a storage device;
b) Altering ethane pressure for intended fueling location to maintain the fuel in a vapor state or liquid state; and,
c) Feeding a measured quantity of fuel to the internal combustion engine.

15. A process of claim 14 where ethane temperature is regulated with pressure.

16. A process of claim 14 where any blend of hydrocarbon, methane, ethane, propane, and butane can be run through adjustments to the components.

17. A process of claim 14 where ethane, propane or butane mixtures can be blended with gasoline or diesel as a high pressure liquid.

18. A process to run internal combustion engines on high ethane blends comprising using of:
a) Supplying fuel from a storage device to store fuel via a supply line to the ethane conversion system for said internal combustion engine;
b) Altering pressure of said ethane fuel feed from said storage device through the supply line;
c) Metering flow of fuel to the internal combustion engine; and,
d) Processing data from sensors connected to said internal combustion engine, pressure altering device, and metering device to run the internal combustion engine.

19. The process of claim 18 where the pressure is controlled via a single or multiple stage pressure regulation.

20. A process of claim 18 where the computer controls operating parameters based on data received and adjusts to maintain internal combustion engine operation.
